(19) United States
(12) Patent Application Publication
(10) Pub. No.: US 2023/0070851 A1
(43) Pub. Date: Mar. 9, 2023

(54) Infinite playback queue manipulation

(71) Applicant: Adam Robert Slattery, Leadville, CO (US)

(72) Inventor: Adam Robert Slattery, Leadville, CO (US)

(21) Appl. No.: 17/467,333

(22) Filed: Sep. 6, 2021

(51) Int. Cl. G06F 3/0484; G06F 3/0482; G06F 16/438

(52) U.S. Cl. CPC G06F 3/0484; G06F 3/0482; G06F 16/4387

(57) ABSTRACT

A media playback queue defining the upcoming playback sequence of media data items may be continually generated using an automatic software function or manual user selections. The playback queue may be edited to modify or re-arrange the upcoming playback sequence. Automatic addition of media data items may be controlled by defining a non-predetermined set of media data items comprising a subset of a media library, such as a combination of filesystem directories or specifically selected metadata tags. The playback queue may be configured to maintain a minimum number of queued media data items, to provide a mechanism of anticipating upcoming media data items intended for playback, and to allow for pre-emptive modification of the playback queue sequence by editing the anticipated playback queue. Th invention provides a controllable method of random shuffled automatic media library playback by providing a novel opportunity to remove undesired items from the playback queue.

### CROSS REFERENCE TO RELATED APPLICATIONS

This application is a continuation of provisional application No. 60,936,778 filed Jun. 22, 2007. Related computer program listing source code was additionally filed with non-provisional utility patent application No. 12,284,344 filed Sep. 20, 2008.

This Substitute Specification contains no new matter in response to USPTO 9/16/2021 Office Action titled “Notice to file missing parts of nonprovisional application.”

### FEDERALLY SPONSORED RESEARCH OR DEVELOPMENT

Not Applicable.

### SEQUENCE LISTING

Not Applicable.

### COMPUTER PROGRAM LISTING APPENDIX

Transmittal letter: CDROM archival disc, program listing source code

Computer Compatibility: IBM PC/XT/AT and compatibles, Apple/Mac, UNIX

Operating System Compatibility: UNIX/Linux, Apple/Macintosh OSX

Line Terminator: DOS; ASCII Carriage Return plus ASCII Line Feed

Control Codes: ASCII character set 0x00-0xef

Compression: uncompressed data

Computer Program Description:
Program listing is included as C source code. The entire demo software program is a prototype application intended for Linux systems using a GNU environment. The included source code implements a novel, innovative software method as a functional software application. The software is not intended for public distribution or publication.

### PRIOR ART

U.S. Pat. No. 6,526,411 System and method for creating dynamic playlists
U.S. Pat. No. 6,748,395 System and method for dynamic playlist of media
U.S. Pat. No. 7,441,192 Programming, selecting, and playing multimedia files

The U.S. Pat. No. 6,928,433 patent is commonly utilized among media playback software user-interfaces, and the U.S. Pat. No. 6,526,411 patent discloses a dynamic playlist method that may be similar to the present invention. Other listed prior art is not directly relevant to the novel features of the present invention.

Publically available software applications of related prior art:

| | |
|---|---|
| Amarok | http://amarok.kde.org |
| Banshee | http://banshee-project.org |
| Xine | http://xinehq.de |
| cmp3 | http://cmp3.sourceforge.net |
| amf | http: //amf.sourceforge. net |
| Winamp | http://www.winamp.com |
| Apple iTunes | http: //www.apple.com/itunes/ |

The algorithm and claims defined in this specification are not based upon or in any way related to prior art. Proprietary source code for a computer program listing provided with this specification does not infringe on any known prior art. Prior disclosures of the invention and computer program listing were made to the USPTO during the course of filing previous application No. 60,936,778 filed Jun. 22, 2007 and non-provisional application No. 12,284,344 filed on Sep. 20, 2008.

The invention has not been published or otherwise publicly disclosed, although source code was maliciously stolen by a suspicious Ukranian named Dennis who physically assaulted the inventor with a sucker punch to the back of the head in Spring 2009 before absconding with a grey backpack that contained archival USB flash drives storing archival backup copies of the prior USPTO filings and a newer source code computer program listing, in addition to other software trade secrets.

### FILE LISTING OF COMPACT DISC CONTENTS

Relevant source code program listings disclosed on CDROM in multiple prior USPTO filings: US non-provisional Utility Patent Application No. 12,284,344 filed Sep. 20, 2008 and provisional utility application No. 60,936,778 filed Jun. 22, 2007. A small patch may be required to compile the source code program using Clang compiler (clang-1200.0.32.28), as tested on Macintosh-OSX version x86_64-apple-darwin19.6.0. GCC/GNU-Linux should not require any patching.

```
  (128 lines) slattery2007-Clang-OSX-minimal-unified-diff-patch.txt 5076 bytes
  (407 lines) slattery2008-Clang-OSX-minimal-unified-diff-patch.txt 13497 bytes
  patch −p 1 < ../slattery2007-Clang-OSX-minimal-unified-diff-patch.txt
  (128 line patch, included): $ cat slattery2007-
  Clang-OSX-minimal-unified-diff-patch.txt
diff −rU 0 slattery2007/Makefile slattery2007osx/Makefile
−−− slattery2007/Makefile 2007-10-09 03:55:30.000000000 −0600
+++ slattery2007osx/Makefile 2021-09-05 09:07:56.000000000 −0600
@@ −2 +2,2 @@
−CFLAGS = −O2 −Wall −Inmenu −ggdb
+#CFLAGS = −O2 −Wall −Inmenu −ggdb
+CFLAGS = −Wall −Inmenu
diff −rU 0 slattery2007/config.h slattery2007osx/config.h
−−− slattery2007/config.h 2007-10-09 03:55:30.000000000 −0600
+++ slattery2007osx/config.h 2021-09-05 09:37:35.000000000 −0600
@@ −0,0 +1,11 @@
+// Simple OSX patch needed to build with Clang compiler... (2020)
+#ifndef u_char
+ #define u_char unsigned char
+ #define u_short unsigned short
+ #define u_long unsigned long
+#endif
+
+#ifndef PATH_MAX
+#define PATH_MAX 512
+#endif
+
diff −rU 0 slattery2007/nmenu/helpbox.c slattery2007osx/nmenu/helpbox.c
−−− slattery2007/nmenu/helpbox.c 2007-10-09 03:55:12.000000000 −0600
+++ slattery2007osx/nmenu/helpbox.c 2021-09-05 09:23:15.000000000 −0600
@@ −206 +206 @@
− mvwaddch( optionwin, 0, optionwin−>_maxx − i − 1,
DAWNCONFIRMATIONOK[i]);
+ mvwaddch(optionwin, 0, getmaxx(optionwin) − i − 1,
DAWNCONFIRMATIONOK[i]);
@@ −210 +210 @@
− mvwaddch(optionwin, 0, optionwin−>_maxx − j − i,
DAWNCONFIRMATIONCANCEL[i]);
+ mvwaddch(optionwin, 0, getmaxx(optionwin) − j − i,
DAWNCONFIRMATIONCANCEL[i]);
diff −rU 0 slattery2007/nmenu/nmenu.c slattery2007osx/nmenu/nmenu.c
−−− slattery2007/nmenu/nmenu.c 2007-10-09 03:55:12.000000000 −0600
+++ slattery2007osx/nmenu/nmenu.c 2021-09-05 09:18:48.000000000 −0600
@@ −64 +64,2 @@
− sw = derwin(w, w−>_maxy−1, w−>_maxx−1, 1, 1);
+//osx sw = derwin(w, w−>_maxy−1, w−>_maxx−1, 1, 1);
+ sw = derwin(w, getmaxy(w)−1, getmaxx(w)−1, 1, 1);
@@ −96,2 +97,4 @@
− mb−>y = w−>_maxy+1;
− mb−>x = w−>_maxx+1;
+//osx mb−>y = w−>_maxy+1;
+ mb−>y = getmaxy(w)+1;
+//osx mb−>x = w−>_maxx+1;
+ mb−>x = getmaxx(w)+1;
diff −rU 0 slattery2007/nmenu/window.c slattery2007osx/nmenu/window.c
−−− slattery2007/nmenu/window.c 2007-10-09 03:55:12.000000000 −0600
+++ slattery2007osx/nmenu/window.c 2021-09-05 09:22:14.000000000 −0600
@@ −329 +329 @@
− x = (win−>_maxx >> 1) − ((x+2) >> 1);
+ x = (getmaxx(win) >> 1) − ((x+2) >> 1);
@@ −359 +359 @@
− mvwprintw(win, 0, x, “ %.*s ”, win−>_maxx−2, title);
+ mvwprintw(win, 0, x, “ %.*s ”, getmaxx(win)−2 , title);
@@ −362 +362 @@
− for(n=0,x=win−>_maxx−x ; x > 0 && title[n] != ‘\0’ ; x−−)
+ for(n=0,x=getmaxx(win)−x ; x > 0 && title[n] != ‘\0’ ; x−−)
@@ −371 +371 @@
− mvwprintw(win, 0, x, “ %.*s ”, win−>_maxx−2, title);
+ mvwprintw(win, 0, x, “ %.*s ”, getmaxx(win)−2, title);
@@ −439,2 +439,2 @@
− x = b + win−>_maxx;
− y = c + win−>_maxy;
+ x = b + getmaxx(win);
+ y = c + getmaxy(win);
@@ −462,2 +462,2 @@
− if(x < minx | | y+win−>_maxy > maxy)
− mvwaddch(win, win−>_maxy, 0, bl);
+ if(x < minx | | y+getmaxy(win) > maxy)
+ mvwaddch(win, getmaxy(win), 0, bl);
@@ −465,2 +465,2 @@
− if(x+win−>_maxx > maxx | | y < miny)
− mvwaddch(win, 0, win−>_maxx, tr);
+ if(x+getmaxx(win) > maxx | | y < miny)
+ mvwaddch(win, 0, getmaxx(win), tr);
@@ −468,2 +468,2 @@
− if(x+win−>_maxx > maxx | | y+win−>_maxy > maxy)
− mvwaddch(win, win−>_maxy, win−>_maxx, br);
+ if(x+getmaxx(win) > maxx | | y+getmaxy(win) > maxy)
+ mvwaddch(win, getmaxy(win), getmaxx(win), br);
@@ −474 +474 @@
− for(a=1 ; a < win−>_maxx ; a++)
+ for(a=1 ; a < getmaxx(win) ; a++)
@@ −484 +484 @@
− for(a=1 ; a < win−>_maxx ; a++)
+ for(a=1 ; a < getmaxx(win) ; a++)
@@ −486 +486 @@
− if(y+win−>_maxy <= maxy && a+x >= minx && a+x <= maxx)
+ if(y+getmaxy(win) <= maxy && a+x >= minx && a+x <= maxx)
@@ −488 +488 @@
− mvwaddch(win, win−>_maxy, a, bs);
+ mvwaddch(win, getmaxy(win), a, bs);
@@ −494 +494 @@
− for(a=1 ; a < win−>_maxy ; a++)
+ for(a=1 ; a < getmaxy(win) ; a++)
@@ −503 +503 @@
− for(a=1 ; a < win−>_maxy ; a++)
+ for(a=1 ; a < getmaxy(win) ; a++)
@@ −505 +505 @@
− if(x+win−>_maxx <= maxx && y+a >= miny && y+a <= maxy)
+ if(x+getmaxx(win) <= maxx && y+a >= miny && y+a <= maxy)
@@ −507 +507 @@
− mvwaddch(win, a, win−>_maxx, ls);
+ mvwaddch(win, a, getmaxx(win), ls);
diff −rU 0 slattery2007/volume.c slattery2007osx/volume.c
−−− slattery2007/volume.c 2007-10-09 03:55:30.000000000 −0600
+++ slattery2007osx/volume.c 2021-09-05 09:15:41.000000000 −0600
@@ −9 +9 @@
−#include <sys/soundcard.h>
+//#include <sys/soundcard.h>
@@ −25,0 +26 @@
+return; //osx patch-- dont use internal volume control...
@@ −46,0 +48 @@
+return; //osx patch-- dont use internal volume control...
@@ −58 +60 @@
− ioct1(mixer_fd, SOUND_MIXER_WRITE_VOLUME, &vol);
+//osx ioct1(mixer_fd, SOUND_MIXER_WRITE_VOLUME, &vol);
@@ −63 +65 @@
− ioct1(mixer_fd, SOUND_MIXER_WRITE_PCM, &vol);
+//osx ioct1(mixer_fd, SOUND_MIXER_WRITE_PCM, &vol);
@@ −73,0 +76 @@
+return 0; //osx patch-- dont use internal volume control...
@@ −77 +80 @@
− if(pcm)
+/*osx if(pcm)
@@ −81 +84 @@
−
+*/
```

2007 and 2008 version USPTO CDROM archives are not identical.

The 2008 source code contains additional proprietary features.

The computer program can be utilized to reproduce the drawings.

Program listing is intended for use on GNU/Linux, though it also functions satisfactorily on Macintosh-OSX with mpg123.

(*Usage Note*) The program asserts the proper version config file was copied onto ~/.ozyrusrc (*_*)

slattery2007/aslattery$ 1s −1*
FILENAME Size(bytes) Timestamp

| slattery2007: | | | | | |
|---|---|---|---|---|---|
| Makefile | 940 | Oct-9-2007 | | | |
| OLDsortmdir.sh | 2624 | Oct-9-2007 | | | |
| TODO | 2362 | Oct-9-2007 | nmenu: | | |
| cdda2wavrename.sh | 287 | Oct-9-2007 | API | 13413 | Oct-9-2007 |
| command.c | 49293 | Oct-9-2007 | Makefile | 773 | Oct-9-2007 |
| command.h | 141 | Oct-9-2007 | README | 81 | Oct-9-2007 |
| config.c | 28246 | Oct-9-2007 | config.h | 134 | Oct-9-2007 |
| config.h | 998 | Oct-9-2007 | helpbox.c | 10813 | Oct-9-2007 |
| dir2m3u.c | 3144 | Oct-9-2007 | input.c | 9165 | Oct-9-2007 |
| func_val.h | 548 | Oct-9-2007 | intbox.c | 7673 | Oct-9-2007 |
| id31n.sh | 2409 | Oct-9-2007 | menu_caption.c | 1862 | Oct-9-2007 |
| input.c | 9461 | Oct-9-2007 | menu_function.c | 999 | Oct-9-2007 |
| key_names.h | 2282 | Oct-9-2007 | menu_intbox.c | 1874 | Oct-9-2007 |
| m3u2dir.c | 2556 | Oct-9-2007 | menu_selection.c | 1228 | Oct-9-2007 |
| ozyrus.c | 14503 | Oct-9-2007 | menu_textbox.c | 2786 | Oct-9-2007 |
| ozyrusrc.DEFAULT | 3950 | Oct-9-2007 | menu_yesno.c | 1651 | Oct-9-2007 |
| playlist.c | 13128 | Oct-9-2007 | nmenu.c | 3352 | Oct-9-2007 |
| queue, c | 8600 | Oct-9-2007 | nmenu.h | 9077 | Oct-9-2007 |
| volume.c | 1621 | Oct-9-2007 | output.c | 14523 | Oct-9-2007 |
| windows.c | 26915 | Oct-9-2007 | selection.c | 2185 | Oct-9-2007 |
| | | | stack.c | 13803 | Oct-9-2007 |
| | | | textbox.c | 8538 | Oct-9-2007 |
| | | | value.c | 4689 | Oct-9-2007 |
| | | | window.c | 10994 | Oct-9-2007 |
| | | | yesno.c | 1377 | Oct-9-2007 |
| | | | readsongtags.c | 13933 | 15Aug2008.12:29 |
| | | | search.c | 5527 | 15Aug2008.09:06 |
| slattery2008/ aslattery$ 1s −1 * | | | setvolume.c | 1455 | 24Jul2008.13:55 |
| | | | usb.c | 18670 | 24Jul2008.13:55 |
| FILENAME Size(bytes) Timestamp | | | volume.c | 2270 | 24Jul2008.13:55 |
| | | | windows.c | 97714 | 15Aug2008.12:26 |
| slattery2008/ | | | | | |
| | | | slattery/nmenu: | | |
| 0TIMESTAMPS | 3566 | 07Sep2008.16:53 | | | |
| INSTALL | 49807 | Sep2008.16:53 | PROPRIETARY | 67 | 07Sep2008.16:53 |
| Makefile | 4117 | 07Sep2008.16:53 | Makefile | 963 | 07Sep2008.16:53 |
| cache.c | 15702 | 24Jul2008.13:55 | config.h | 520 | 29Jul2008.14:27 |
| command.c | 85602 | 01Sep2008.14:59 | fd_pipe.c | 1706 | 31Jul2008.16:48 |
| command.h | 141 | 24Jul2008.13:55 | heap.c | 15941 | 29Jul2008.14:24 |
| config.c | 37942 | 09Aug2008.23:32 | helpbox. c | 3243 | 07Sep2008.14:15 |
| config.h | 2120 | 24Jul2008.13:55 | input.c | 17825 | 02Aug2008.17:51 |
| debug.c | 2732 | 24Jul2008.13:55 | intbox.c | 7897 | 29Jul2008.14:24 |
| dir2m3u.c | 3144 | 24Jul2008.13:55 | menucaption.c | 2184 | 29Jul2008.14:24 |
| fd_pipe.c | 1706 | 24Jul2008.13:55 | menu_function.c | 1180 | 29Jul2008.14:24 |
| funcval.h | 835 | 24Jul2008.13:55 | menuintbox.c | 2106 | 29Jul2008.14:24 |
| gpod.c | 44818 | 01Aug2008.17:56 | menuselection.c | 1564 | 29Jul2008.14:24 |
| input, c | 18120 | 03Sep2008.21:11 | menutextbox.c | 3133 | 29Jul2008.14:24 |
| iszombiepid.c | 1210 | 24Jul2008.13:55 | menu_yesno.c | 1818 | 29Jul2008.14:24 |
| itdb.h | 51976 | 24Jul2008.13:55 | newmenu.c | 6434 | 29Jul2008.14:24 |
| key_names.h | 2282 | 24Jul2008.13:55 | nmenu.h | 15870 | 05Sep2008.22:53 |
| metatag.c | 13501 | 10Aug2008.08:59 | output.c | 16907 | 29Jul2008.14:24 |
| nmenu | 4096 | 07Sep2008.16:53 | selection.c | 2491 | 29Jul2008.14:24 |
| ozyrus.c | 29594 | 01Sep2008.11:09 | textbox.c | 8695 | 29Jul2008.14:24 |
| ozyruscpsuid.c | 6064 | 09Aug2008.23:53 | value.c | 6009 | 29Jul2008.14:24 |
| ozyrusrc.DEFAULT | 7099 | 07Sep2008.16:53 | window.c | 12968 | 05Sep2008.20:07 |
| playlist.c | 27847 | 24Jul2008.13:55 | yesno.c | 1377 | 29Jul2008.14:24 |
| queue.c | 20057 | 01Sep2008.11:09 | | | |

### FIELD OF THE INVENTION

This invention relates to a computer-implemented method of software and hardware used to facilitate playback of media data items, such as digital audio files or digital video files. The invention is used to continually generate and manipulate a non-predetermined media playback sequence using a dynamic media playback queue to control the precise playback order for a plurality of media data items intended for playback.

### BACKGROUND OF THE INVENTION

The invention described is utilized to control the sequence of media data playback for a plurality of music or video media data items comprising a media library. A user may utilize the invention during the course of playing a plurality of media data items to anticipate which media data items will be played next, and to manipulate the queued sequence of media data items by modifying the playback ordering or altering the content of the playback queue.

Prior art has provided a method of enabling shuffled playback that can randomly select one media data item to begin playing after completing playback of a previously playing media data item. Prior art often utilizes a playlist of pre-selected media data items, but the present invention provides a novel innovation to utilize a continuous playback queue that is not constrained to a pre-defined set of media data items. A primary object of the invention is a method to simplify the task of selecting media data items for playback.

The invention provides a method for a user to rapidly select one or more media data items intended for immediate playback, and also a method to leave the software unattended during continuous playback or optionally modify the continuous playback sequence as it is generated. In prior art, random playback is often problematically unpredictable. The present invention solves the problem of unanticipated random selection by providing opportunity to utilize a dynamic playback queue to alter the upcoming intended playback sequence of media data files.

The present invention allows continual and perpetual selection of media data items by accessing any arbitrary subset of media data items comprising a media library. The invention provides a playback queue that enables continual manipulation of the upcoming playback sequence to control the order of media data items intended for playback, and a mechanism to continually and automatically add media data items to the playback queue from a media library, with a continuing ability to manually remove automatically added media data items that are deemed undesirable. The utility of these capabilities are novel when compared to prior art.

The best mode of the invention utilizes a minimum playback queue size that can be configured or adjusted to meet user requirements or preferences. When considering the desire to utilize random shuffled playback of media data items comprising a media library, a user of the invention may want to abstain from explicitly selecting any media data items for the playback queue and instead defer to random shuffled selection, but may nonetheless be familiar with the content of the media library and have a preference for which randomly selected media data items should actually be played and the order in which they will actually be played. In prior art, it is unknown what media data item will be randomly selected next until a shuffled playback function advances and begins playback of previously undetermined media data item. The present invention allows one to precisely select only the most desirable randomly chosen media data items by removing undesirable media data items from the upcoming playback queue, before playback of the randomly chosen media data items ever begins. The present invention also allows one to defer playback of certain randomly selected media data items by manipulating the playback queue sequence to instead play other selected media data items first, or conversely to expedite a queued media data item for sooner playback than other selected media data items.

The invention is well suited for an alarm clock where it may be desirable to have some control over what media data items will be played before actually commencing the playback, such that a person might not want to wake up listening to the exact same digital audio every day, but also wants some control of the upcoming playback queue to know that suitably loud and upbeat audio is queued that will be sufficiently loud to arouse the sleeping person. The motivation behind this embodiment was the problem of setting a radio alarm clock before school and often having it turn on to verbal radio advertisements or obnoxious DJ conversations, instead of the desired music typically played by a selected analogue FM radio station the alarm clock was tuned into at bed time when setting the alarm. The invention may be utilized as an alarm clock in this novel manor by generating a desired playback queue of media data items that will commence playback by means of a wakeup timer function that simply resumes playback from a paused state; a further, optional embodiment may also utilize a bedtime timer to forcibly pause media data item playback in the evening, in similar fashion to a lightbulb that is automatically controlled using a 24-hour timer instead of a switch.

### SUMMARY OF THE INVENTION

Media playback from a media library may be controlled by a software user-interface capable of dynamically generating a continuous playback sequence as a playback queue of media data items. The playback queue may be re-ordered or edited at any time to determine the precise order that a plurality of selected media data items will be played.

Sequences of media data items can be specified manually by inserting media data items into the playback queue, or generated automatically by algorithmic selection from a set of media data items comprising a media data library or a subset of the media data library. Editing the playback queue to remove undesired media data items that the user does not want played back can trigger automatic addition of different media data items to the playback queue, using a minimum queue size limit to maintain at least a minimum number of media data items intended for playback, thereby always allowing a user to knowingly anticipate the media data items about to be played.

Automatic selection of media data items for addition to the playback queue can be controlled using a software user-interface to specify a precise set of media data items available for playback selection. The set of media data items available for automatic playback selection may be any arbitrary subset of a media library. A traditional mechanism of defining a subset of the media library involves selection of a specific filesystem directory or selection of a specific metadata tag. Multiple filesystem directories may also be selected to specify a more diverse set of media data items. A recursive filesystem navigation function may also be utilized to generate a set of all the media data items comprising all of the sub-directories within one or more directory tree hierarchies of a media library.

Manual insertion of media data items into the playback queue may utilize absolute precision. Selected media data items can be added to the beginning of the playback queue to become the next played media data item, or to the end of the playback queue to be played following any other already pending media data items. The playback queue may be edited so that removed media data items will not actually be played, thereby advancing any subsequent pending media data items closer towards the beginning of the playback queue. The playback queue may also be edited to alter the sequence of pending media data items, such that a selected media data item may be relocated to a precise playback queue position that may be closer to the beginning or end of the playback queue.

### BRIEF DESCRIPTION OF DRAWINGS

These and other features of the invention will be readily apparent to those skilled in the art, and the invention will be readily understood from the following descriptions of the invention as depicted by the accompanying drawings, wherein a chronological sequence of several text-based terminal screenshots are provided to graphically illustrate various features of the invention.

FIG. 1 depicts a simple text-terminal user-interface with a media library navigation list (2) and an empty playback queue (1) with zero media data items intended for playback; no media data items have yet been loaded into the media library navigation list, so none are available yet.

FIG. 2 depicts the playback queue (1) was populated with five media data items(4) that were automatically selected and inserted, after the navigation list (2) was used to open a filesystem directory(3) containing a plurality of media data items. Playback was initiated.

FIG. 3 depicts the playback queue was modified with the addition of one media data item (5) to the end of the playback queue(1), and the navigation list (2) shows more media data items within the same subset of the media library depicted in FIG. 2.

FIG. 4 depicts a further modified playback queue (1) wherein two undesired media data items were removed from the playback queue, and one media data item was inserted at the top of the playback queue (6), to be played next. Elapsed play time of the currently playing media data item is near completion (7).

FIG. 5 depicts a further modified playback queue (1) wherein the playback queue was automatically advanced to the next media data item. Additional media data items have been selected for insertion to both the top (8) and bottom (9) of the play queue. The navigation list (2) shows an entirely different filesystem directory (3).

FIG. 6 depicts an automatic advancement of the play queue (1) following completion of the previously playing media data item, but no media data items are automatically added because the play queue size did not yet fall below the minimum play queue size.

FIG. 7 depicts the manual insertion of two media data items to the beginning (10) of the playback queue (1).

FIG. 8 depicts the manual removal of several media data items from the playback queue (1) after playback was automatically advanced to the next pending media data item (11). The navigation list (2) was again changed using user-input to select an entirely different subset of the media library (3).

FIG. 9 depicts a further advancement of the playback queue (1), and this advancement triggered automatic selection and insertion of two randomly selected media data items (12) from the navigation list (2) that was changed in FIG. 8, to satisfy a minimum queue size.

FIG. 10 depicts a further advancement of the playback queue (1) and manual editing to remove several undesired media data items. The removal of the undesired media data items triggered automatic addition of media data items (13) from the subset specified by the navigation list (2), in order to maintain a minimum queue size.

FIG. 11 depicts advancement of the playback queue (1) to the next pending media data item(14), and manual insertion of several selected media data items (15) into the playback queue.

FIG. 12 depicts the minimum playback queue size being relied upon after a different subset (3) of the media library was selected using user-input in the navigation list (2). Multiple playback queue advancements took place until the queue size fell below the minimum queue size, so additional media data items (16) were automatically selected for insertion from the most recently selected subset (3) of the media library. Beethoven and Bach music media data items (16) were automatically added following playback of the various rap-genre media data items (15) that were manually added to the playback queue (1) in FIG. 11.

FIG. 13 depicts one additional classical-genre media data item (17) was added to the playback queue (1) from the navigation list (2) depicted in FIG. 12, before changing the navigation list (2) back to the rap-genre subset (3) of media data items depicted in FIGS. 8, 9, 10, 11 in order to select one additional media data item (18) that was also added to the playback queue (1). The playback queue ordering was then modified so the pending classical-genre media data items (16) will be played before the pending rap-genre media data items (15) and (18).

FIG. 14 depicts an empty subset of media data items within the media library in the navigation window(2), whereby no media data items are available(18). The minimum queue size was therefore not maintained. Playback of future pending media data items in the playback queue (1) was completed except for the last item (19) that is currently playing. All of the previously played media data items were removed from the playback queue.

FIG. 15 depicts the navigation window (2) using an alternate mode not presented in previous figures that simultaneously presents a large scrollable listing of media data items and their comprising directories as a sorted list, generated automatically from a plurality of filesystem directories that were recursively opened, read, and sorted into the presented listing of media data items, and the playback queue (1) is configured as a larger set than was utilized in previous figures, to fully illustrate the adjustable nature of a configurable minimum queue size.

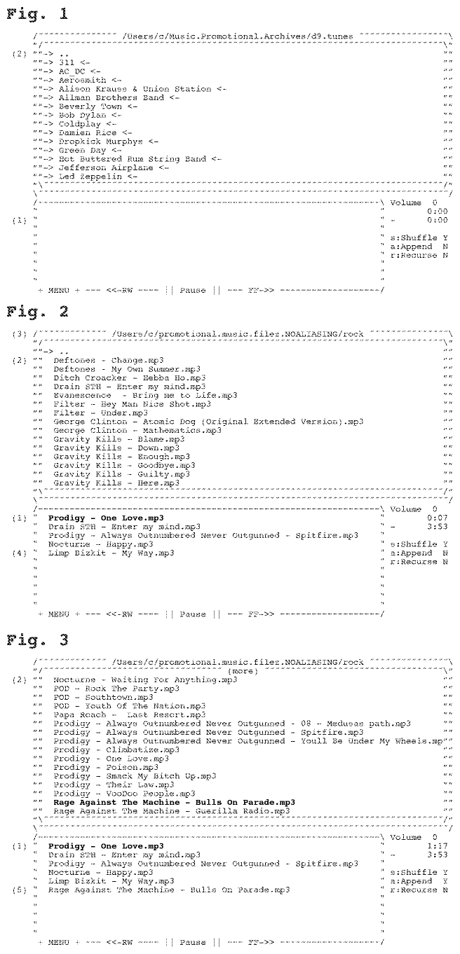

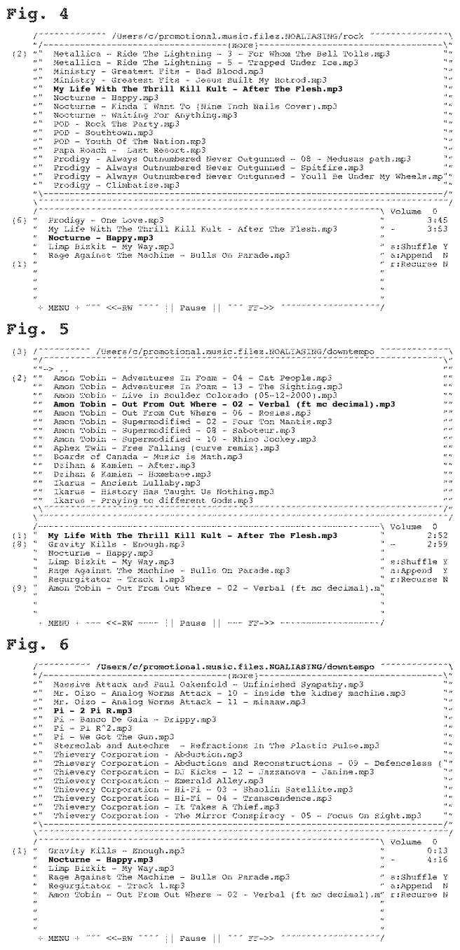

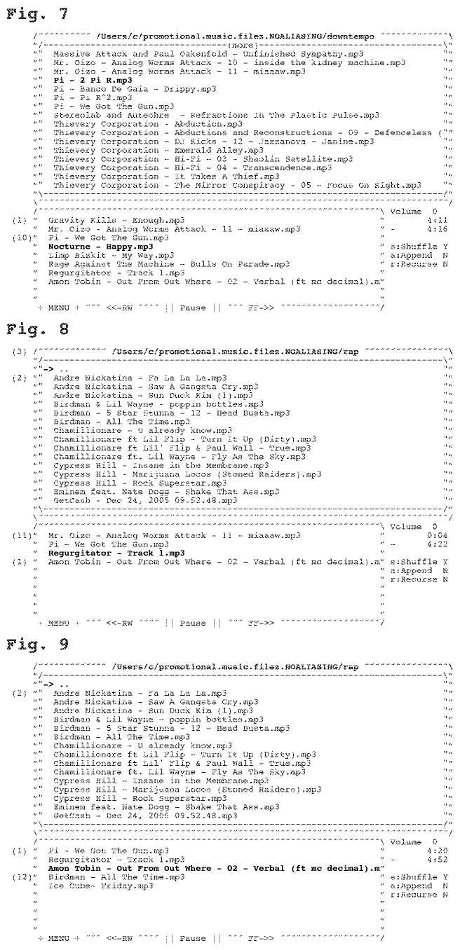

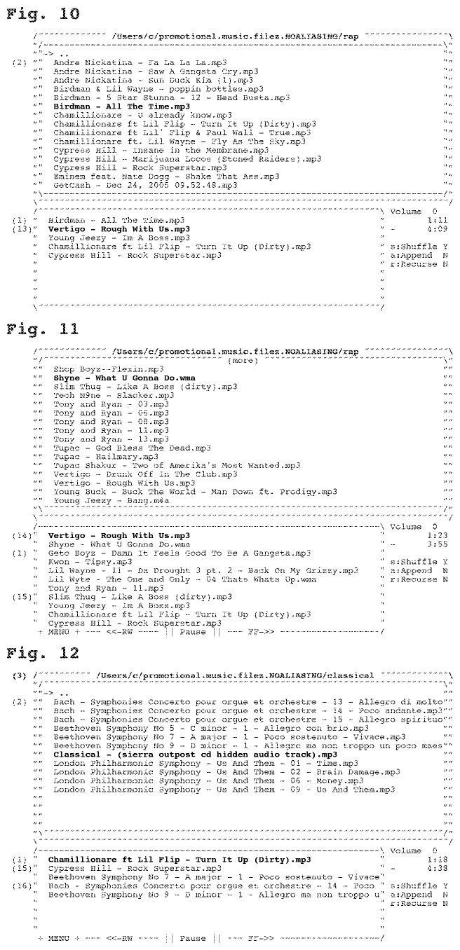

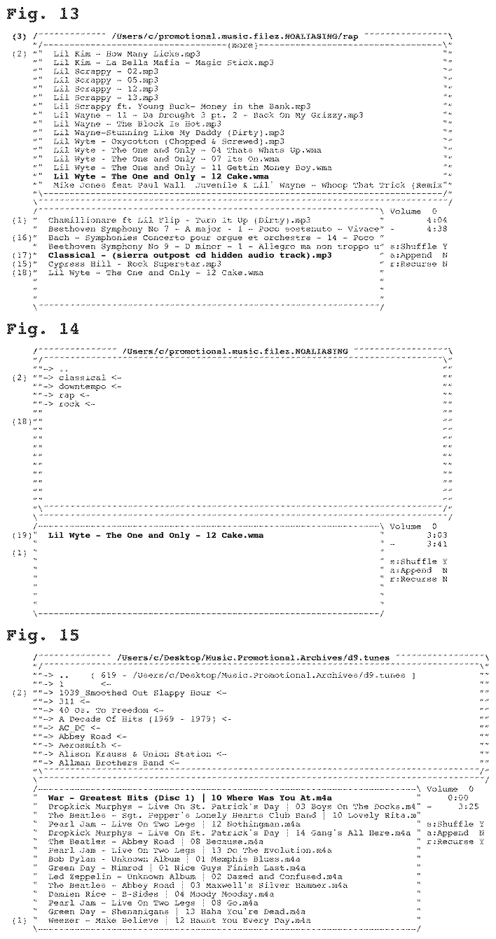

### DETAILED DESCRIPTION

The invention provides a method to dynamically generate a sequence of media data items as a playback queue, by selecting media data items from a media library or a subset of the media library. The playback queue may be simultaneously displayed to the user on-screen along with a media library subset navigation list used to select and display a set of media data items available for selection.

The playback queue may be edited using user-interface software to re-arrange the sequence of media data items intended for playback. Media data items may also be manually inserted into the playback queue in a specifically desired position, or removed from the playback queue.

A novel mechanism of defining a subset of the media library is a function to recursively navigate the set of all media data items within the current working directory and all sub-directories to the deepest computable extent of the sub-directory structures. A different subset of the media library may similarly be generated by recursively accumulating the set of media data items located within multiple selected filesystem directories and all of the recursively accessible sub-directories. A subset of the media library is used to control which media data items may be added to the playback queue. The playback queue may also be controlled using a more traditional subset of the media library, such as the list of all available media data items comprising a specific filesystem directory, or from a playlist containing a fixed set of media data items.

The upcoming sequence of media data items comprising the playback queue should have a user-configurable minimum number of media data items. Whenever the actual number of media data items in the queue is smaller than the minimum, media data items should be automatically added to maintain a minimum queue size. A minimum queue size provides an opportunity for monitoring the playback queue in order to facilitate manual removal of undesirable media data items from the playback queue. A minimum queue size represents the best-mode contemplated by the inventor.

A subset of the media library is used to automatically generate the queue, and this set of media data items may be accessed randomly or sequentially, depending on a user preference for shuffle mode. Whenever a media data item is automatically added to the queue, it is inserted at the end of the queue so that the upcoming sequence of intended media data items remains undisturbed.

1. A computer-implemented method comprising:
software and hardware to access media data items and facilitate media data playback;
a media library comprising a plurality of multiple media data items stored on at least one storage device, though a media library may optionally be comprised of media data items stored on multiple storage devices, wherein such storage devices used to store media data items comprising a media library may include hard drives, disk drives, solid state flash memory, network-based cloud storage services, remote network file system protocols, or remote network-based communications protocols whereby media data items may be accessed using network protocol software to communicate the media data items from a remote server;
a playback queue comprising one or more media data items pending for future intended playback following completion of a currently playing media data item;
a sequential queue advancement function to automatically initiate playback of a next pending media data item from the playback queue when playback of a currently playing media data item completes, such that the currently playing media data item is removed from the playback queue before the next pending media data item becomes the currently playing media data item;
an automatic media data item selection mechanism is used to maintain a minimum playback queue size by algorithmically selecting a media data item from the media library for addition to the end of the playback queue for future intended playback whenever the playback queue size is smaller than the configured minimum playback queue size, in order to maintain the minimum playback queue size, such that the newly added automatically selected media data item is intended for playback subsequent to any media data items already pending in the playback queue, wherein this mechanism of maintaining a minimum playback queue size may be utilized as a method for continuous media playback operation.

2. The invention set forth in claim 1, wherein:
the automatic media data item selection mechanism used to maintain a minimum playback queue size algorithmically selects a media data item from within a limited subset of media data items out of the total plurality of media data items comprising the entire media library, wherein:
a user-input method is utilized to specify a limited subset of media data items from the plurality of media data items comprising the entire media library, in order to more precisely control which media data items from within the media library are to be utilized by the automatic media data item selection mechanism for media data item addition to the playback queue, such that an inverse subset of unavailable media data items comprises the presently undesirable media data items that are not to be utilized for automatic media data item selection whenever it becomes necessary to maintain a minimum playback queue size using automatic selection of a media data item;
a user-input method can be utilized to modify the subset of media data items or to specify an alternate subset of media data items.

3. A computer-implemented method comprising:
software and hardware to access media data items and facilitate media data playback;
a media library comprising a plurality of multiple media data items stored on at least one storage device, though a media library may optionally be comprised of media data items stored on multiple storage devices, wherein such storage devices used to store media data items comprising a media library may include hard drives, disk drives, solid state flash memory, network-based cloud storage services, remote network file system protocols, or remote network-based communications protocols whereby media data items may be accessed using network protocol software to communicate the media data items from a remote server;
a playback queue comprising one or more media data items pending for future intended playback following completion of a currently playing media data item;
a sequential queue advancement function to automatically initiate playback of a next pending media data item from the playback queue when playback of a currently playing media data item completes, such that the currently playing media data item is removed from the playback queue before the next pending media data item becomes the currently playing media data item;
a user-input mechanism to select a media data item within the playback queue in order to move that media data item to an alternate position within the playback queue, thereby altering the sequence of the media data items in the playback queue to better satisfy the user's playback sequence preference.

4. A computer-implemented method comprising:
software and hardware to access media data items and facilitate media data playback;
a media library comprising a plurality of multiple media data items stored on at least one storage device, though a media library may optionally be comprised of media data items stored on multiple storage devices, wherein such storage devices used to store media data items comprising a media library may include hard drives, disk drives, solid state flash memory, network-based cloud storage services, remote network file system protocols, or remote network-based communications protocols whereby media data items may be accessed using network protocol software to communicate the media data items from a remote server;
a playback queue comprising one or more media data items pending for future intended playback following completion of a currently playing media data item;
a sequential queue advancement function to automatically initiate playback of a next pending media data item from the playback queue when playback of a currently playing media data item completes, such that the currently playing media data item is removed from the playback queue before the next pending media data item becomes the currently playing media data item;
a user-input mechanism to manually select a desired media data item from the media library for insertion into the playback queue, wherein the addition to the playback queue may be precisely controlled to place the selected media data item within the playback queue, at the beginning or end of the playback queue or elsewhere.

5. The invention set forth in claim 1, further comprising:
a user-input mechanism to select a media data item within the playback queue in order to move that media data item to an alternate position within the playback queue, thereby altering the sequence of the media data items in the playback queue to better satisfy the user's playback sequence preference.

6. The invention set forth in claim 4, further comprising:
a user-input mechanism to select a media data item within the playback queue in order to move that media data item to an alternate position within the playback queue, thereby altering the sequence of the media data items in the playback queue to better satisfy the user's playback sequence preference.

7. The invention set forth in claim 1, further comprising:
a user-input mechanism to manually select a desired media data item from the media library for insertion into the playback queue, wherein the addition to the playback queue may be precisely controlled to place the selected media data item within the playback queue, at the beginning or end of the playback queue or elsewhere.

8. The invention set forth in claim 3, further comprising:
a user-input mechanism to manually select a desired media data item from the media library for insertion into the playback queue, wherein the addition to the playback queue may be precisely controlled to place the selected media data item within the playback queue, at the beginning or end of the playback queue or elsewhere.

9. The invention set forth in claim 1, further comprising:
a user-input mechanism to remove an undesired media data item from the playback queue.

10. The invention set forth in claim 3, further comprising:
a user-input mechanism to remove an undesired media data item from the playback queue.

11. The invention set forth in claim 4, further comprising:
a user-input mechanism to remove an undesired media data item from the playback queue.

12. The invention set forth in claim 1, further comprising:
a user-input mechanism to manually select a desired media data item from the media library for insertion into the playback queue using user-input to provide direct user-control of which position within the playback queue the selected media data item should be inserted;

13. The invention set forth in claim 3, further comprising:
a user-input mechanism to manually select a desired media data item from the media library for insertion into the playback queue using user-input to provide direct user-control of which position within the playback queue the selected media data item should be inserted;

14. The invention set forth in claim 4, further comprising:
a user-input mechanism to manually select a desired media data item from the media library for insertion into the playback queue using user-input to provide direct user-control of which position within the playback queue the selected media data item should be inserted;

15. The invention set forth in claim 1, further comprising:
a user-input mechanism to select a media data item already contained within the playback queue in order to play the selected media data item more than once by inserting an additional entry of the selected media data item into the playback queue.

16. The invention set forth in claim 3, further comprising:
a user-input mechanism to select a media data item already contained within the playback queue in order to play the selected media data item more than once by inserting an additional entry of the selected media data item into the playback queue.

17. The invention set forth in claim 4, further comprising:
a user-input mechanism to select a media data item already contained within the playback queue in order to play the selected media data item more than once by inserting an additional entry of the selected media data item into the playback queue.

18. The invention set forth in claim 1, further comprising:
an alarm clock function used to pause or unpause playback by interrupting or recommencing playback of the playback queue, at a configurable future time or set of times.

19. The invention set forth in claim 3, further comprising:
an alarm clock function used to pause or unpause playback by interrupting or recommencing playback of the playback queue, at a configurable future time or set of times.

20. The invention set forth in claim 4, further comprising:
an alarm clock function used to pause or unpause playback by interrupting or recommencing playback of the playback queue, at a configurable future time or set of times.
